(19) United States
(12) Patent Application Publication
(10) Pub. No.: US 2017/0273258 A1
(43) Pub. Date: Sep. 28, 2017

(54) SYSTEM AND METHOD FOR DYNAMIC IRRIGATION MANAGEMENT

(71) Applicant: Prospera Technologies, Ltd., Tel-Aviv (IL)

(72) Inventors: Raviv ITZHAKY, Maale Adumim (IL); Daniel KOPPEL, Raanana (IL); Simeon SHPIZ, Bat Yam (IL)

(73) Assignee: Prospera Technologies, Ltd., Tel-Aviv (IL)

(21) Appl. No.: 15/471,622

(22) Filed: Mar. 28, 2017

Related U.S. Application Data
(60) Provisional application No. 62/313,990, filed on Mar. 28, 2016.

(51) Int. Cl. A01G 25/16; B05B 12/12

(52) U.S. Cl. CPC A01G 25/16; A01G 25/165; B05B 12/12

(57) ABSTRACT

A system and method for dynamic irrigation management. The method includes continuously obtaining thermal signals captured in a farm area, the farm area including at least one crop; analyzing the obtained thermal signals, wherein the analysis includes comparing the obtained thermal signals to a plurality of combinations of predetermined thermal signals, wherein each combination is associated with a known watering state, each combination including at least one type of thermal signal, wherein the thermal signals are captured by at least one thermal sensor deployed in the farm area; determining, based on the analysis, a current watering state of the at least one crop; and generating, in real-time, an irrigation pattern for the farm area based on the determined current watering state.

### CROSS-REFERENCE TO RELATED APPLICATIONS

This application claims the benefit of U.S. Provisional Application No. 62/313,990 filed on Mar. 28, 2016, the contents of which are hereby incorporated by reference.

### TECHNICAL FIELD

The present disclosure relates generally to irrigation management, and more particularly to computer-aided methods for providing uniformly accurate irrigation patterns.

### BACKGROUND

Despite the rapid growth of the use of technology in many industries, agriculture continues to utilize manual labor to perform the tedious and often costly processes for growing vegetables, fruits, and other crops. One primary driver of the continued use of manual labor in agriculture is the need for guidance and consultation by experienced agronomists with respect to developing plants. Such guidance and consultation is crucial to the success of larger farms.

Agronomy is the science of producing and using plants for food, fuel, fiber, and land reclamation. Agronomy involves use of principles from a variety of arts including, for example, biology, chemistry, economics, ecology, earth science, and genetics. Modern agronomists are involved in issues such as improving quantity and quality of food production, managing the environmental impacts of agriculture, extracting energy from plants, and so on. Agronomists often specialize in areas such as crop rotation, irrigation and drainage, plant breeding, plant physiology, soil classification, soil fertility, weed control, and insect and pest control.

The plethora of duties assumed by agronomists require critical thinking to solve problems. For example, when planning to improve crop yields, an agronomist must study a farm's crop production in order to discern the best ways to plant, harvest, and cultivate the plants, regardless of climate. Additionally, agronomists may predict crop yield, which is the measure of agricultural output. To these ends, the agronomist must continually monitor progress to ensure optimal results. Based on the presence or lack of developmental problems as well as observation of plant growth, agronomists may be further able to alter ongoing treatment of plants to ensure optimal yield.

A key factor considered by agronomists observing plants is irrigation. Irrigation is a process in which a controlled amount of water is provided at regular intervals for agriculture. Irrigation is typically utilized to ensure that plants are provided with sufficient water to grow, and may also be used for protecting plants against frost, suppressing weed growth, and preventing soil consolidation. Irrigation is vital to providing acceptable quality and yield of crops, particularly in arid climates. To this end, agronomists estimate timing and amounts of water for proper plant growth based on their observations. In particular, many agronomists strive to obtain uniformly accurate irrigation such that plants are always provided the exact amount of water needed for optimal development.

Reliance on manual observation of plants is time-consuming, expensive, and often inaccurate. Specifically, existing solutions for irrigation management often result in overestimating or underestimating water requirements due to, for example, human error during observation, errors due to approximations made during measurements, and the like. Accordingly, existing solutions often result in at least somewhat inaccurate irrigation management, thereby resulting in, for example, wasted water due to overwatering, insufficient yield or weed growth due to underwatering, and the like.

Further, existing solutions typically utilize estimates of irrigation requirements based on periodic measurements that occur daily or weekly. Such daily and weekly estimates are needed for scheduling irrigations and, therefore, must be performed well in advance of determined irrigation timings in order to allow for agronomists to plan an irrigation schedule. As a result, existing solutions cannot dynamically adapt to changing circumstances, thereby causing further inaccuracies in irrigation planning.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for dynamic irrigation management. The method comprises: continuously obtaining thermal signals captured in a farm area, the farm area including at least one crop; analyzing the obtained thermal signals, wherein the analysis includes comparing the obtained thermal signals to a plurality of combinations of predetermined thermal signals, wherein each combination is associated with a known watering state, each combination including at least one type of thermal signal, wherein the thermal signals are captured by at least one thermal sensor deployed in the farm area; determining, based on the analysis, a current watering state of the at least one crop; and generating, in real-time, an irrigation pattern for the farm area based on the determined current watering state.

Certain embodiments disclosed herein also include a non-transitory computer readable medium having stored thereon causing a processing circuitry to execute a process, the process comprising: continuously obtaining thermal signals captured in a farm area, the farm area including at least one crop; analyzing the obtained thermal signals, wherein the analysis includes comparing the obtained thermal signals to a plurality of combinations of predetermined thermal signals, wherein each combination is associated with a known watering state, each combination including at least one type of thermal signal, wherein the thermal signals are captured by at least one thermal sensor deployed in the farm area; determining, based on the analysis, a current watering state of the at least one crop; and generating, in real-time, an irrigation pattern for the farm area based on the determined current watering state.

Certain embodiments disclosed herein also include a system for dynamic irrigation management. The system comprises: a processing circuitry; and a memory, the memory containing instructions that, when executed by the processing circuitry, configure the system to: continuously obtaining thermal signals captured in a farm area, the farm area including at least one crop; analyzing the obtained thermal signals, wherein the analysis includes comparing the obtained thermal signals to at least one plurality of combinations of predetermined thermal signals, wherein each combination is associated with a known watering state, each combination including at least one type of thermal signal, wherein the thermal signals are captured by at least one thermal sensor deployed in the farm area; determining, based on the analysis, a current watering state of the at least one crop; generating, in real-time, an irrigation pattern for the farm area based on the determined current watering state.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of an irrigation manager according to an embodiment.

FIG. 3 is a flowchart illustrating a method for dynamic irrigation management according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for dynamic irrigation management. Thermal signals captured by thermal sensors deployed in a farm area including at least one crop are continuously obtained. The thermal signals are analyzed. The analysis includes comparing the thermal signals to predetermined thermal signals associated with known watering states. Based on the analysis, a current watering state of the at least one crop is determined. An irrigation pattern for the farm area is generated, in real-time, based on the current watering state. The irrigation pattern indicates at least one irrigation parameter such as, but not limited to, amounts of water, irrigation schedules, type of water, type of fertilizer, irrigation techniques, and the like.

In some embodiments, the steps for generating irrigation patterns may be performed repeatedly at predetermined time intervals or when a thermal signal change event is detected (e.g., when a change above a predetermined change threshold occurs or when a thermal signal passes a predetermined signal threshold), thereby allowing for variable rate irrigation in the farm area. Variable rate irrigation is a method for improving water use efficiency in which irrigation patterns can be modified to meet the specific demands of crops at any point in time by an irrigator system such as, for example, a pivot irrigation system.

Various embodiments described herein are discussed with respect to managing irrigation for at least one crop in a farm area. It should be noted that the at least one crop includes any crops to be irrigated and may include, but is not limited to, at least one plant, at least one portion of a plant, and the like. It should also be noted that the farm area is any area in which the at least one crop grows, and may include, but is not limited to, soil in which the at least one crop is grown, environment surrounding the at least one crop (e.g., an airspace above the at least one crop), a combination thereof, and the like.

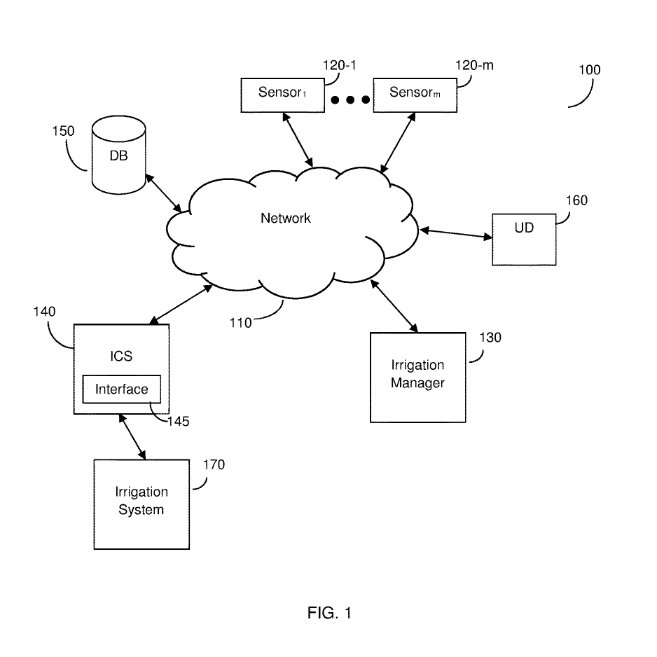

FIG. 1 shows an example network diagram 100 utilized to describe the various disclosed embodiments. The example network diagram 100 includes a plurality of sensors 120-1 through 120-m (hereinafter referred to collectively as sensors 120 and individually as a sensor 120, merely for simplicity purposes), an irrigation manager 130, an irrigation control system (ICS) 140, and a database (DB) 150 communicatively connected via a network 110. In an optional embodiment, a user device (UD) 160 may be further communicatively connected to the network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The sensors 120 include at least one thermal sensor. Each thermal sensor is configured to provide temperature measurements via an electric signal. Each of the sensors 120 may be stationary, mobile, or affixed to a mobile unit, and is configured to capture thermal signals related to at least one crop. The thermal signals may include, but are not limited to, temperature (e.g., a temperature in a crop or a portion thereof, a temperature of air in proximity to a crop), radiation levels, and the like. The thermal signals may further be associated with time data indicating a time of capture of each thermal signal. The sensors 120 may include, but are not limited to, an infrared camera, a temperature sensor, an infrared thermometer, a combination thereof, and the like. The sensors 120 are deployed at least in proximity to the at least one crop (e.g., within a predetermined threshold distance of one or more of the at least one crop), and may further be in direct contact with at least a portion of the at least one crop (e.g., physically touching a stem of a plant).

The irrigation control system 140 is communicatively connected to an irrigation system 170, thereby allowing the irrigation control system 140 to cause irrigation of a farm area including at least one crop via the irrigation system 170. The irrigation system 170 may be, but is not limited to, a central pivot irrigation system, a linear irrigation system, a combination thereof, and the like. The central pivot irrigation system includes, but is not limited to, rotating particles located around a pivot configured to irrigate the at least one crop via sprinklers. The irrigation system 170 may include, but is not limited to, one or more irrigation devices (e.g., sprinklers, irrigation channels, spraying vehicles, drones, etc.) and is deployed in proximity to the at least one crop, thereby allowing the irrigation control system 140 to control irrigation of the at least one crop in accordance with irrigation plans generated by the irrigation manager 130.

The irrigation control system 140 may be deployed remotely from the at least one crop and configured to control the irrigation system 170, thereby allowing the irrigation control system 140 to indirectly cause irrigation of the at least one crop in accordance with irrigation plans generated by the irrigation manager 130. Alternatively, the irrigation control system 140 may include the irrigation system 170, thereby allowing the irrigation control system 140 to directly cause irrigation of the at least one crop in accordance with the generated irrigation plans. It should be noted that the irrigation system 170 may be configured to provide different amounts of water, different types of water (e.g., water treated with different chemicals or having different purities), other fluids, fertilizers, combinations thereof, and the like, as needed for crop development.

The irrigation control system 140 may include an interface 145 for receiving, e.g., instructions from the irrigation manager 130 (e.g., instructions indicating a configuration for implementing an irrigation pattern generated by the irrigation manager 130). The interface 145 may be, but is not limited to, a network interface.

The database 150 has stored therein data utilized for generating irrigation patterns such as, but not limited to, predetermined thermal signals and associated known water states, irrigation pattern data utilized for configuring the irrigation system 170, watering states, both, and the like. The irrigation pattern data may include, but are not limited to, irrigation timings, required amounts of water, types of water to be supplied during irrigation (e.g., a water purity level, a type of treated water, or both), types of fertilizers to be supplied during irrigation, irrigation techniques to be utilized during irrigation, and the like.

In an embodiment, the irrigation manager 130 is configured to continuously receive at least thermal signals from the sensors 120. In a further embodiment, the irrigation manager 130 may be configured to retrieve (e.g., from the database 150) data related to the at least one crop. The data may include, but is not limited to, soil data, types of plants of the at least one crop, both, and the like. The soil data may include, but is not limited to, soil type, texture, electrical conductivity, water holding capacity, and the like.

In an embodiment, the irrigation manager 130 is configured to analyze the thermal signals to determine a current watering state of the at least one crop. In a further embodiment, the irrigation manager 130 is configured to compare the thermal signals to a plurality of predetermined thermal signals associated with known watering states. The analysis may further include, but is not limited to, one or more differential thermal analysis techniques, one or more differential scanning calorimetric techniques, a combination thereof, and the like. In yet a further embodiment, determining the current watering state includes retrieving metadata indicating one of the known watering states. The metadata may indicate, for example, a time since the last watering, whether the at least one crop is sufficiently watered, both, and the like.

In an embodiment, based on the determined current watering state, the irrigation manager 130 is configured to generate, in real-time, an irrigation pattern for the at least one crop. The irrigation pattern includes at least one irrigation parameter related to irrigation management for the at least one crop. The at least one irrigation parameter includes an irrigation schedule and at least one amount of water required with respect to the schedule. The irrigation schedule includes at least one time for irrigation. The at least one irrigation parameter may further include, but is not limited to, a type of water to use, a type of other fluids to use, at least one type of fertilizer, at least one irrigation technique, a combination thereof, and the like. To this end, in a further embodiment, the irrigation manager 130 is configured to retrieve, from the database 150, at least a portion of the irrigation pattern based on the determined current watering state.

In an embodiment, the irrigation manager 130 is configured to cause the irrigation control system 140 to irrigate the at least one crop according to the generated irrigation pattern. In a further embodiment, the irrigation manager 130 is configured to send the generated irrigation plan to the irrigation control system 140, thereby configuring the irrigation control system 140.

The user device (UD) 160 may be, but is not limited to, a personal computer, a laptop, a tablet computer, a smartphone, a wearable computing device, or any other device capable of receiving and displaying irrigation pattern information. In an embodiment, the irrigation manager 130 is configured to send the generated irrigation pattern to the user device 160. In a further embodiment, the user device 160 is configured to display the sent irrigation patterns and to send instructions for implementing the irrigation patterns to the irrigation control system 140 based on user inputs (e.g., a user input indicating approval of an irrigation pattern generated by the irrigation manager 130, user inputs indicating modifications to such a generated irrigation pattern, etc.).

In an embodiment, the analysis of the thermal signals, determination of current watering states, generation of irrigation patterns, and sending of generated irrigation patterns may be repeatedly performed by the irrigation manager 130. In a further embodiment, a new irrigation pattern may be sent in real-time, e.g., at predetermined time intervals, when a significant change in thermal signals is detected, or both. A significant change in thermal signals may be detected, for example, when a change in at least one of the thermal signals above a predetermined threshold (e.g., a threshold value or threshold proportion) occurs, when at least one of the thermal signals is above or below a predetermined threshold, and the like.

It should be noted that the embodiments described herein with respect to FIG. 1 are merely examples, and that the embodiments disclosed herein are not limited to the diagram shown in FIG. 1. In particular, multiple user devices or no user devices may be communicatively connected to the network to receive irrigation patterns without departing from the scope of the disclosure.

Additionally, in an embodiment, the irrigation control system 140 may be incorporated in the irrigation manager 130, thereby allowing the irrigation manager 130 to control irrigation operations based on generated irrigation patterns. In a further embodiment, the irrigation manager 130 may be assembled on the irrigation system 170 deployed in the farm area.

It should be further noted that the sensors 120 may be incorporated in or directly connected to the irrigation managers 130, thereby allowing the irrigation manager 130 to capture the thermal signals.

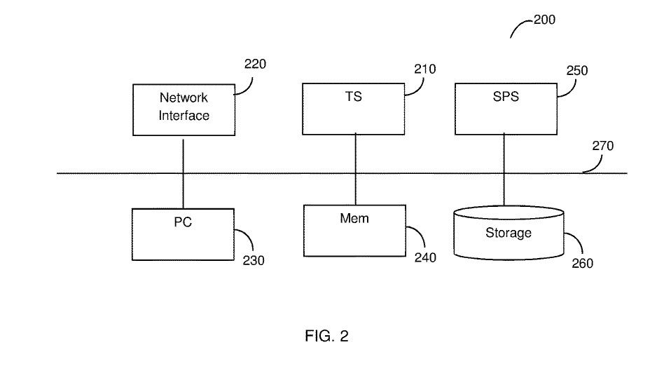

FIG. 2 is an example schematic diagram of the irrigation manager 130 according to an embodiment. The irrigation manager 130 includes a network interface 220, a processing circuitry (PC) 230 coupled to a memory (mem) 240, and a storage 260. In an embodiment, the components of the irrigation manager 130 may be communicatively connected via a bus 270.

In an optional embodiment, the irrigation manager 130 may include one or more thermal sensors (TS) 210. The thermal sensors 210 may include, but are not limited to, an infrared camera, a temperature sensor, an infrared thermometer, a combination thereof, and the like. The thermal sensors 210 may be stationary or mobile, and are configured to continuously capture thermal signals related to the at least one crop.

In another optional embodiment, the irrigation manager 130 may include a solar power system (SPS) 250. The solar power system 250 is configured to capture sunlight and to convert the sunlight into electricity, thereby powering the irrigation manager 130 during operation, charging the irrigation manager 130, or both. The solar power system may include any system for converting solar energy into electrical energy, now known or hereinafter developed, and may include, but is not limited to, solar panels for capturing solar energy, a solar converter for converting solar energy into electrical energy, and the like.

The network interface 220 allows the irrigation manager 130 to communicate with the sensors 120, the irrigation control system 140, the database 150, the user device 160 or a combination of, for the purpose of, for example, receiving thermal signals, sending irrigation patterns, configuring the irrigation control system 140, retrieving data related to known watering states (e.g., associated predetermined thermal signals, irrigation patterns utilized for addressing particular watering states, etc.), combinations thereof and the like.

The processing circuitry 230 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 240 may be volatile (e.g., RAM, etc.), non-volatile (e.g., ROM, flash memory, etc.), or a combination thereof. In another embodiment, the memory 240 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 230 to perform the various processes described herein. Specifically, the instructions, when executed, cause the processing circuitry 230 to dynamic irrigation management, as discussed hereinabove.

The storage 260 may be magnetic storage, optical storage, and the like, and may be realized, for example, as flash memory or other memory technology, CD-ROM, Digital Versatile Disks (DVDs), or any other medium which can be used to store the desired information. In one implementation, computer readable instructions to implement one or more embodiments disclosed herein may be stored in the storage 260. In another implementation, the storage 260 may store soil data for the farm area, data utilized to generate irrigation patterns (e.g., recommendations associated with different watering states), both, and the like.

It should be understood that the embodiments described herein are not limited to the specific architecture illustrated in FIG. 2, and other architectures may be equally used without departing from the scope of the disclosed embodiments.

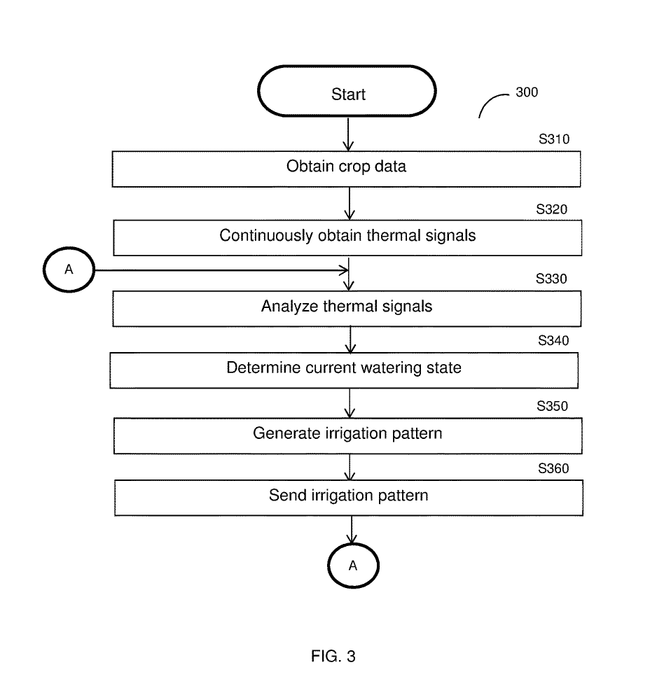

FIG. 3 is an example flowchart 300 illustrating a method for dynamic irrigation management according to an embodiment. In an embodiment, the method may be performed by the irrigation manager 130. In another embodiment, the irrigation management is performed with respect to a farm area including at least one crop, thereby providing irrigation patterns for the at least one crop.

At optional S310, data related to the at least one crop may be obtained. The obtained crop data may include soil data (e.g., soil data associated with soil in which the at least one crop is planted), type data (e.g., types of plants among the at least one crop), and the like. The soil data may include, but is not limited to, soil type, texture, electrical conductivity, water holding capacity, and the like. In an embodiment, S320 may include, but is not limited to, retrieving the soil data from a database, identifying the soil data in a storage, and the like.

At S320, thermal signals related to the farm area are continuously obtained. The thermal signals are captured via one or more thermal sensors, and may be received from the thermal sensors. The thermal signals may include, but are not limited to, temperature (e.g., a temperature in a crop or a portion thereof, a temperature of air in proximity to a crop), radiation levels, and the like.

At S330, at least the thermal signals are analyzed. In an embodiment, the analysis includes comparing the obtained thermal signals to a plurality of combinations of predetermined thermal signals associated with known watering states. Each combination of predetermined thermal signals includes at least one distinct type of thermal signal (e.g., temperature in crop, temperature in air, radiation, etc.), where each combination of at least one thermal signal is associated with one of the known watering states. As a non-limiting example, a temperature in the air near a crop of 65 degrees and a temperature of 60 degrees in the crop may be associated with a first known watering condition, while a temperature in the air near a crop of 65 degrees and a temperature of 70 degrees in the crop may be associated with a second known watering condition. As another non-limiting example, a first radiation level may be associated with a first known watering state, while a second radiation level may be associated with a second known watering state. In a further embodiment, the analysis may further include one or more differential thermal analysis techniques, one or more differential scanning calorimetric techniques, a combination thereof, and the like.

In an embodiment, the analysis may further be based on the obtained soil data. In a further embodiment, the analysis may include comparing a combination of the thermal signals and the soil data with predetermined combinations of thermal signals and soil data, where each predetermined combination is associated with a known watering condition.

At S340, based on the analysis, a current watering state of the at least one crop is determined. In an embodiment, the determined current watering state may be a known watering state associated with a set of thermal signals matching the obtained thermal signals. In a further embodiment, the thermal signals may match a predetermined set of thermal signals, e.g., if the thermal signals are within a predetermined range of thermal signals, if the thermal signals do not exceed a predetermined thermal signal threshold, and the like.

At S350, based on the determined current watering state, an irrigation pattern for irrigating the at least one crop is generated. In an embodiment, the irrigation pattern is generated in real-time. The irrigation pattern includes at least one irrigation parameter. The at least one irrigation parameter includes an irrigation schedule and at least one amount of water required with respect to the schedule. The irrigation schedule includes at least one time for irrigation. The at least one irrigation parameter may further include, but is not limited to, a type of water to use, a type of other fluids to use, at least one type of fertilizer, at least one irrigation technique, a combination thereof, and the like.

In a further embodiment, the generation of the irrigation pattern is further based on a type of plant of the at least one crop (e.g., a type indicated in the crop data obtained at S310). Different characteristics of plants may result in different crops needing specific parameters for irrigation, thereby requiring different irrigation patterns.

At optional S360, the generated irrigation pattern may be sent and execution continues with S330. The irrigation pattern may be sent to, for example, a user device (e.g., the user device 160, FIG. 1), an irrigation control system (e.g., the irrigation control system 140, FIG. 1), and the like. The irrigation pattern may be sent to a user device for, e.g., approval by a user of the user device, modification by a user of the user device, and the like. The irrigation pattern may be sent to the irrigation control system to allow for reconfiguring of an irrigation system controlled by the irrigation control system in accordance with the irrigation pattern.

Alternatively, S360 may include controlling irrigation of the at least one crop based on the generated irrigation pattern. The control may include, but is not limited to, controlling timings of irrigation, controlling amounts of materials for irrigation, controlling types of materials used for irrigation, implementing specific irrigation techniques (e.g., sprinkler-based irrigation, channel-based irrigation, etc.), combinations thereof, and the like.

In an embodiment, execution may continue with S330 when a predetermined amount of time passes, when a significant change in thermal signals is detected, or either. A significant change may be detected when, e.g., a change in at least one thermal signal is above a predetermined threshold change value or proportion, at least one thermal signal goes above or below a predetermined threshold signal value, and the like.

Continuously capturing thermal signals and repeatedly generating new irrigation patterns respective thereof allows for dynamic management of irrigation for the at least one crop. The dynamic management provides increased accuracy of the irrigation at least due to modifying irrigation plans in real-time as circumstances of the at least one crop change and comparing objective values to determine current watering states, thereby resulting in efficient consumption of irrigation materials (e.g., water, fertilizer, other fluids, etc.) and improved crop development.

It should be noted that FIG. 3 is depicted as including obtaining thermal signals at step S310 merely for simplicity purposes and without limitation on the disclosed embodiments. In a typical embodiment, the thermal signals are obtained continuously in parallel with execution of steps S330 through S360. New thermal signals may be analyzed and irrigation patterns may be generated thereto at each iteration of the method.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for dynamic irrigation management, comprising:
continuously obtaining thermal signals captured in a farm area, the farm area including at least one crop;
analyzing the obtained thermal signals, wherein the analysis includes comparing the obtained thermal signals to a plurality of combinations of predetermined thermal signals, wherein each combination is associated with a known watering state, each combination including at least one type of thermal signal, wherein the thermal signals are captured by at least one thermal sensor deployed in the farm area;
determining, based on the analysis, a current watering state of the at least one crop; and
generating, in real-time, an irrigation pattern for the farm area based on the determined current watering state.

2. The method of claim 1, wherein the irrigation pattern includes at least one of: an amount of water required, and a watering schedule.

3. The method of claim 1, wherein continuously obtaining the thermal signals further comprises:
capturing the thermal signals using the at least one thermal sensor deployed in the farm area.

4. The method of claim 1, further comprising:
detecting, based on the obtained thermal signals, changes in the thermal signals, wherein each of the steps of analyzing the obtained thermal signals, determining the current watering state, and generating an irrigation pattern for the farm area is repeated when a change in the thermal signals above a threshold is detected.

5. The method of claim 1, wherein each of the steps of analyzing the obtained thermal signals, determining the current watering state, and generating an irrigation pattern for the farm area is repeated at predetermined time intervals.

6. The method of claim 1, further comprising:
sending the irrigation pattern to a device equipped with a display, wherein the sent irrigation pattern is displayed on the device.

7. The method of claim 1, further comprising:
configuring an irrigation system with the irrigation pattern, wherein the irrigation system, configured with the irrigation pattern, irrigates the at least one crop according to the irrigation pattern.

8. The method of claim 1, wherein the thermal signals indicate at least one of: an air state in proximity to the at least one crop and a temperature of at least one of the at least one crop.

9. The method of claim 1, further comprising:
obtaining soil data for the farm area including the at least one crop, wherein the current watering state is determined further based on the soil data, wherein the soil data includes at least one of: soil type, texture, electrical conductivity, and water holding capacity.

10. The method of claim 1, wherein the irrigation pattern is generated further based on a type of the at least one crop.

11. A non-transitory computer readable medium having stored thereon instructions for causing a processing circuitry to execute a process, the process comprising:
continuously obtaining thermal signals captured in at least a portion of a farm area, the farm area including at least one crop;
analyzing the obtained thermal signals, wherein the analysis further comprises comparing the obtained thermal signals to a plurality of combinations of predetermined thermal signals, wherein each combination is associated with a known watering state, each combination including at least one type of thermal signal, wherein the thermal signals are captured by at least one thermal sensor deployed in the farm area;
determining, based on the analysis, a current watering state of the at least one crop;
generating, in real-time, an irrigation pattern for the farm area based on the determined current watering state.

12. A system for dynamic irrigation management, comprising:
a processing circuitry; and
a memory, the memory containing instructions that, when executed by the processing circuitry, configure the system to:
continuously obtaining thermal signals captured in a farm area, the farm area including at least one crop;
analyzing the obtained thermal signals, wherein the analysis includes comparing the obtained thermal signals to at least one plurality of combinations of predetermined thermal signals, wherein each combination is associated with a known watering state, each combination including at least one type of thermal signal, wherein the thermal signals are captured by at least one thermal sensor deployed in the farm area;
determining, based on the analysis, a current watering state of the at least one crop;
generating, in real-time, an irrigation pattern for the farm area based on the determined current watering state.

13. The system of claim 12, wherein the irrigation pattern includes at least one of: an amount of water required, and a watering schedule.

14. The system of claim 12, wherein the system further comprises:
at least one sensor, wherein the at least one sensor is deployed in the farm area, wherein the system is further configured to:
continuously capture, via the at least one thermal sensor deployed in the farm area, the thermal signals.

15. The system of claim 12, wherein the system is further configured to:
detect, based on the continuously obtained thermal signals, changes in the thermal signals, wherein each of the steps of analyzing the obtained thermal signals, determining the current watering state, and generating an irrigation pattern for the farm area is repeated when a change in the thermal signals above a predetermined threshold is detected.

16. The system of claim 12, wherein each of the steps of analyzing the obtained thermal signals, determining the current watering state, and generating an irrigation pattern for the farm area is repeated at predetermined time intervals.

17. The system of claim 12, wherein the system is further configured to:
send the irrigation pattern to a device equipped with a display, wherein the sent irrigation pattern is displayed on the device.

18. The system of claim 12, wherein the system is further configured to:
configure an irrigation system with the irrigation pattern, wherein the irrigation system configured with the irrigation pattern automatically irrigates the at least one crop according to the irrigation pattern.

19. The system of claim 12, wherein the thermal signals indicate at least one of: an air state in proximity to the at least one crop, and a temperature of at least one of the at least one crop.

20. The system of claim 12, wherein the system is further configured to:
obtain soil data for the farm area including the at least one crop, wherein the current watering state is determined further based on the soil data, wherein the soil data includes at least one of: soil type, texture, electrical conductivity, and water holding capacity.

21. The system of claim 12, wherein the irrigation pattern is generated further based on a type of the at least one crop.
